(19) United States
(12) Patent Application Publication
(10) Pub. No.: US 2024/0375704 A1
(43) Pub. Date: Nov. 14, 2024

(54) Steering Gear for a Steering System of a Utility Vehicle

(71) Applicant: Robert Bosch GmbH, Stuttgart (DE)

(72) Inventors: Walter Kogel, Abtsgmuend (DE); Martin Maier, Schwaebisch Gmuend (DE); Michael Haegele, Aalen (DE); Tobias Nowak, Pluederhausen (DE)

(21) Appl. No.: 18/692,072

(22) PCT Filed: Aug. 8, 2022
(86) PCT No.: PCT/EP2022/072196

§ 371 Date: Mar. 14, 2024

(30) Foreign Application Priority Data
Sep. 27, 2021 (DE) 10 2021 210 741.9

(51) Int. Cl. B62D 5/04

(52) U.S. Cl. CPC B62D 5/0403; B62D 5/0481

(57) ABSTRACT

A steering gear for a steering system of a utility vehicle includes a first drive unit, which is operatively connected to an output shaft by a first helical gear transmission, for applying a first steering assist torque to the output shaft; and a second drive unit, which is operatively connected to the output shaft by a second helical gear transmission, for applying a second steering assist torque to the output shaft. The first drive unit defines a first longitudinal axis and has a first rotational position about the first longitudinal axis. The second drive unit defines a second longitudinal axis and has a second rotational position about the second longitudinal axis, which differs from the first rotational position.

The invention relates to a steering system of a utility vehicle.

### THE PRIOR ART

Vehicles, particularly heavy utility vehicles, are often equipped with hydraulic or electro-hydraulic steering supports. In heavy trucks, the type of steering of the ball nut power steering system has prevailed in many areas.

In addition, in conjunction with an electrical actuator, a hydraulic valve is actuated by means of the driver-initiated steering torque, which generates an output torque on the output shaft.

A system in which two drive units are used is, e.g., also known from the following publication.

DE 102017205721A1 discloses a transmission unit for a motor vehicle having an output shaft running along an X direction, at least one worm gear coupled thereto, and a first worm shaft running along a Y direction perpendicular to the X direction, with which at least one worm gear interacts and is coupled to a first motor unit with torque transfer.

A second worm shaft interacts with the at least one worm gear and is coupled to a second motor unit with torque transfer. The first worm shaft further interacts with a first portion of the at least one worm gear.

The second worm shaft also interacts with a second portion of the at least one worm gear arranged offset in the X direction for this purpose, whereby a first worm gear and a second worm gear are coupled to the output shaft, and whereby the first portion is formed on the first worm gear and the second portion is formed on the second worm gear.

If the hydraulics fail in a ball nut power steering system, the driver is considered to be the fallback level to bring the vehicle to a halt. In addition, in electro-hydraulic steering systems as described hereinabove, the driver is the fallback level for possible malfunctions in the control unit of the electrical actuator or hydraulics. With autonomous driving, however, the “driver” fallback level no longer exists.

Therefore, it must be ensured that the electrical system does not fail completely. Furthermore, drive units can be arranged in parallel in the same rotational position about their own axis perpendicular to the output shaft. The disadvantage thereby is that vibrations can damage both drive units simultaneously or that electromagnetic fields affect both drive units in the same way, and this cannot be detected and an unwanted signal is output.

The object of the invention is therefore to provide a steering gear in which failure cases as a result of vibrations or electromagnetic fields are not simultaneously occurring or detected and safe continued travel or safe removal from traffic is possible without driver intervention.

Said object is achieved by means of a steering gear for a steering system of a utility vehicle having the features of claim 1.

### DISCLOSURE OF THE INVENTION

The present invention creates a steering gear for a steering system of a utility vehicle.

The steering gear comprises a first drive unit operatively connected to an output shaft by a first helical gear transmission, in particular a first electric motor connected to a first steering control unit, for applying a first steering assist torque to the output shaft.

The steering gear further comprises a second drive unit operatively connected to the output shaft by a second helical gear transmission, in particular a second electric motor connected to a second steering control unit, for applying a second steering assist torque to the output shaft.

The first drive unit has a first rotational position about its longitudinal axis. Further, the second drive unit has, about its longitudinal axis, a second rotational position which differs from the first rotational position.

One idea of the present invention is to provide an improved steering gear in which failure cases as a result of vibrations or electromagnetic fields are not simultaneously occurring or detected and safe continued travel or safe removal from traffic is possible without driver intervention.

Due to the different rotational position of the first drive unit and the second drive unit, a possible electromagnetic influence on the drive units is detected differently by a Hall sensor installed in the respective drive unit and can thus be detected as a source of error. Such an arrangement of the drive units further causes simultaneous damage by external influences to become unlikely.

Advantageous embodiments and further developments emerge from the dependent claims and from the description with reference to the drawings.

According to one preferred embodiment, it is provided that the first drive unit and the second drive unit are arranged parallel to one another and have an inclination angle of greater than or less than 90° to a longitudinal axis of the output shaft.

Due to the non-vertical arrangement of the drive units towards the output shaft, a reduction of the required design space can advantageously be achieved.

According to a further preferred embodiment, it is provided that the first drive unit and the second drive unit are arranged parallel to one another, whereby the first drive unit has a first inclination angle to a transverse axis of the output shaft and the second drive unit has a second inclination angle to the transverse axis of the output shaft which differs from the first inclinational angle.

The radially offset arrangement of the first drive unit to the second drive unit with respect to the transverse axis of the output shaft has the advantage that the drive units are exposed to a different influence when exposed to electromagnetic radiation, such that the Hall sensor installed in the respective drive unit detects the electromagnetic radiation differently. This can thus be detected as a source of error and is thus not able to exert a harmful influence on the steering.

According to a further preferred embodiment, it is provided that the first inclination angle to the transverse axis of the output shaft has an angular difference to the second inclination angle to the transverse axis of the output shaft.

Such an arrangement of the drive units ensures that there is a sufficient angular offset between them and the transverse axis of the output shaft and thus electromagnetic radiation acting on the drive units is detected differently by them.

According to a further preferred embodiment, it is provided that the first drive unit has a first inclination angle to the longitudinal axis of the output shaft and the second drive unit has a second inclination angle to the longitudinal axis of the output shaft which differs from the first inclination angle.

The first drive unit and the second drive unit are thus not arranged parallel to each other but at different angles to the longitudinal axis of the output shaft. This advantageously has the effect that the probability of damage by mechanical influences, e.g. rock impact, can be reduced. Such an arrangement for detecting electronic fields as a source of error is also advantageous.

According to a further preferred embodiment, it is provided that the first drive unit has a first inclination angle to the transverse axis of the output shaft and the second drive unit has a second inclination angle to the transverse axis of the output shaft which differs from the first inclination angle.

Such an arrangement of the drive units ensures that there is a sufficient angular offset between them and the transverse axis of the output shaft and thus electromagnetic radiation acting on the drive units is detected differently by them.

According to a further preferred embodiment, it is provided that the first drive unit and the second drive unit are arranged askew to one another.

The askew arrangement of the first derivative of the second drive unit also advantageously effects an improved detectability of electromagnetic influences due to the different detection of the influences on the first and second drive unit by the Hall sensor installed in the drive units.

According to a further preferred embodiment, it is provided that the first helical gear transmission and the second helical gear transmission are arranged on the same shaft, in particular on the same input shaft or from the same output shaft. As a result, redundant steering assistance or autonomous steering can be provided for the autonomous driving application.

According to a further preferred embodiment, it is provided that the first drive unit or the second drive unit comprises a shielding, in particular a ferromagnetic shielding, which shields a first Hall sensor arranged in the first steering control unit or a second Hall sensor arranged in the second steering control unit.

By providing shielding on only one of the drive units, an electro-political effect on the drive units can be advantageously detected by the Hall sensors installed in the drive units due to the signal attenuation caused by the shielding.

According to a further preferred embodiment, it is provided that the rotational position of the first drive unit about its longitudinal axis has an angular difference to the rotational position of the second drive unit about its longitudinal axis.

Such an arrangement of the drive units ensures that there is a sufficient angular offset between them and the transverse axis of the output shaft and thus electromagnetic radiation acting on the drive units is detected differently by them. As a result, the likelihood of damage to both drive units due to, e.g., vibration or mechanical influences can be reduced as a result.

The embodiments and further developments described can be combined with one another as desired.

Further possible embodiments, further developments, and implementations of the invention also include feature combinations not described or explicitly specified hereinabove or hereinafter with respect to exemplary embodiments.

### BRIEF DESCRIPTION OF THE DRAWINGS

The accompanying drawings are intended to provide a better understanding of the embodiments of the invention. The drawings illustrate embodiments and, in connection with the description, serve to explain principles and concepts of the invention.

Further embodiments and many of the specified advantages will emerge with reference to the drawings. The elements shown in the drawings are not necessarily drawn to scale with respect to one another.

Shown are:

FIG. 1 a schematic illustration of a steering gear for a steering system of a utility vehicle according to a first embodiment of the invention;

FIG. 2 a schematic illustration of the steering gear for the steering system of the utility vehicle according to a second embodiment of the invention; and

FIG. 3 a schematic illustration of the steering gear for the steering system of the utility vehicle according to a third embodiment of the invention.

In the figures shown in the drawings, identical reference signs denote identical or functionally identical elements, parts, or components, unless stated otherwise.

A servo unit of the steering gear 1 has an input shaft 10 and an output shaft 12 having a mechanical stop connected by a rotational rod. A magnet is located on the input shaft 10, and a torque and angle sensor 15 is located on the output shaft 12.

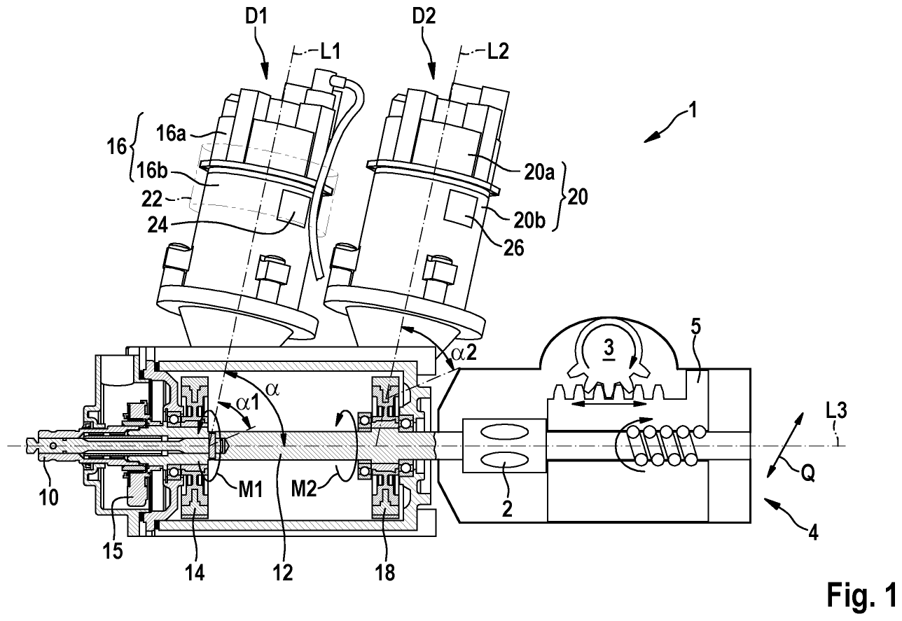

The steering gear 1 for a steering system shown in FIG. 1, in particular a ball nut power steering system, of a utility vehicle comprises a first drive unit 16, which is operatively connected to the output shaft 12 by a first helical gear transmission 14, in particular a first electric motor 16b connected to a first steering control unit 16a, for applying a first steering assist torque M1 to the output shaft 12. Alternatively, the steering system can, e.g., be in the form of an electric steering system.

Furthermore, the steering gear comprises a second drive unit 20 operatively connected to the output shaft 12 by a second helical gear transmission 18, in particular a second electric motor 20b connected to a second steering control unit 20a, for applying a second steering assist torque M2 to the output shaft 12.

The steering gear further comprises that the first drive unit 16 has a first rotational position D1 about its longitudinal axis L1 and the second drive unit 20 has, about its longitudinal axis L2, a second rotational position D2 which differs from the first rotational position D1.

The first drive unit 16 and the second drive unit 20 are arranged parallel to each other. Furthermore, the first drive unit 16 and the second drive unit 20 have an inclination angle α of less than 90° to a longitudinal axis L3 of the output shaft 12.

Alternatively, the first drive unit 16 and the second drive unit 20 can have an inclination angle α of greater than 90° to a longitudinal axis L3 of the output shaft 12.

The first drive unit 16 and the second drive unit 20 are arranged parallel to each other. The first drive unit 16 has a first inclination angle α1 to the transverse axis of the output shaft 12 and the second drive unit 20 has a second inclination angle α2 to the transverse axis of the output shaft 12 which differs from the first inclination angle α1.

The first inclination angle α1 to the transverse axis Q of the output shaft 12 has an angular difference to the second inclination angle α2 to the transverse axis Q of the output shaft 12.

The first helical gear transmission 14 and the second helical gear transmission 18 are arranged on the same output shaft 12.

Alternatively, the first helical gear transmission 14 and the second helical gear transmission 18 can be arranged on the same input shaft 10.

The first drive unit 16 or the second drive unit 20 comprise a shielding 22, in particular a ferromagnetic shielding, which shields a first Hall sensor 24 arranged in the first steering control unit 16a or a second Hall sensor 26 arranged in the second steering control unit 20a.

The rotational position D1 of the first drive unit 16 about its longitudinal axis L1 has an angular difference to the rotational position D2 of the second drive unit 20 about its longitudinal axis L2.

Furthermore, the output shaft 12 is connected to a hydraulic valve 2. Furthermore, a segment shaft 3 of the ball nut hydraulic power system 4 is connected to the output shaft 12 via a piston 5.

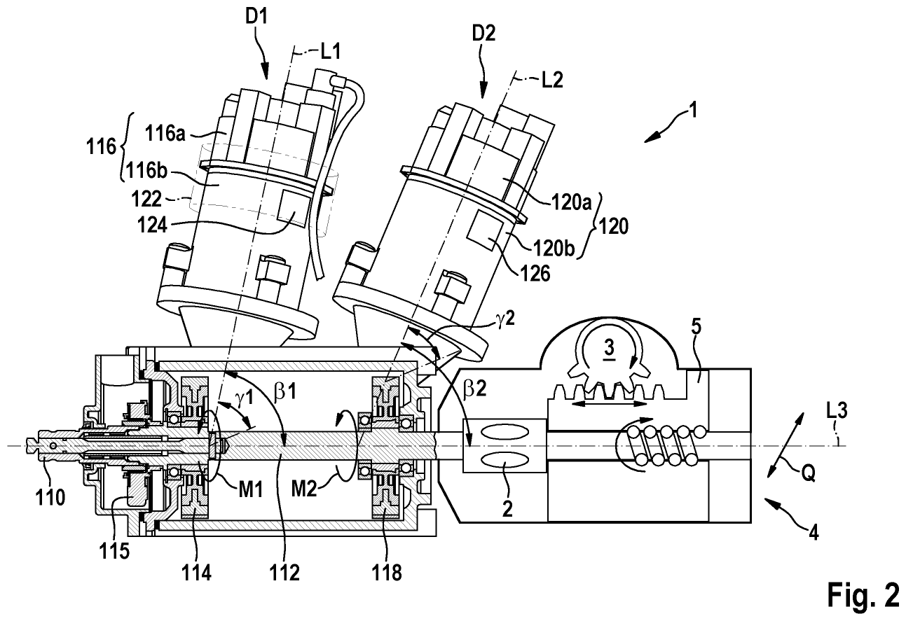

FIG. 2 shows a schematic illustration of the steering gear for the steering system of the utility vehicle according to a second embodiment of the invention.

The first drive unit 116 has a first inclination angle β1 to the longitudinal axis L3 of the output shaft 110, 112 and the second drive unit 120 has a second inclination angle β2 to the longitudinal axis L3 of the output shaft 110, 112 which differs from the first inclination angle β1.

Furthermore, the first drive unit 116 has a first inclination angle γ1 to the transverse axis Q of the output shaft 110, 112 and the second drive unit 120 has a second inclination angle γ2 to the transverse axis Q of the output shaft 110, 112 which differs from the first inclination angle γ1.

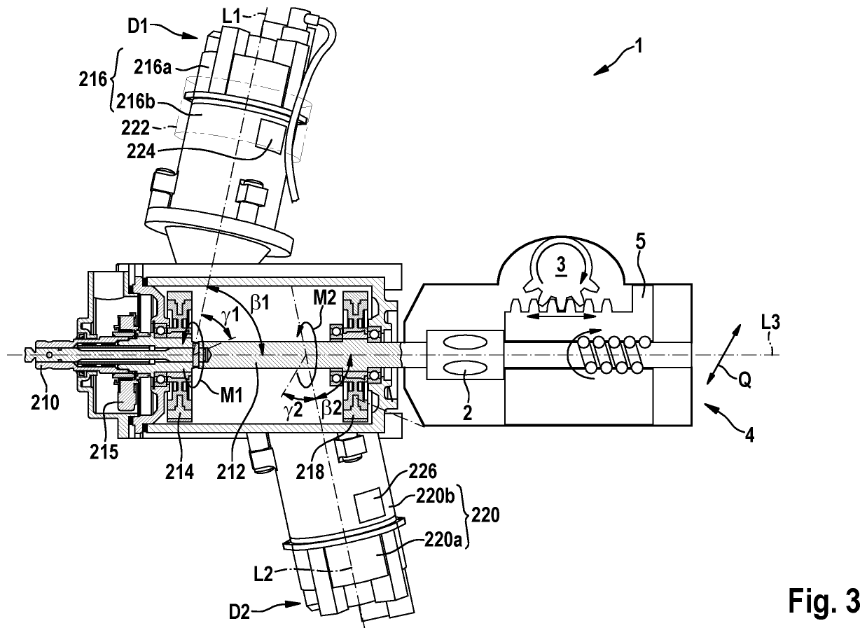

FIG. 3 shows a schematic illustration of the steering gear for the steering system of the utility vehicle according to a third embodiment of the invention, whereby the first drive unit 216 and the second drive unit 220 are arranged askew to one another.

### LIST OF REFERENCE SIGNS

1. Steering gear
2. Hydraulic valve
3. Segment shaft
4. Ball nut power steering
5. Piston
10, 110, 210 Input shaft
12, 112, 212 Output shaft
14, 114, 214 First helical gear transmission
15, 115, 215 Torque and angle sensor
16, 116, 216 First drive unit
16a, 116a, 216a First steering control unit
16b, 116b, 216b First electric motor
18, 118, 218 Second helical gear transmission
20, 120, 220 Second drive unit
20a, 120a, 220a Second steering control unit
20b, 120b, 220b Second electric motor
22, 122, 222 Ferromagnetic shielding
24, 124, 224 First Hall sensor
26, 126, 226 Second Hall sensor
D1 First rotation position
D2 Second rotation position
L1 First longitudinal axis
L2 Second longitudinal axis
L3 Longitudinal axis
M1 First steering assist torque
M2 Second steering assist torque
Q Transverse axis
α Angle of inclination
α1, β1, γ1 First inclination angle
α2, β2, γ2 Second inclination angle

1. A steering gear for a steering system of a utility vehicle, comprising:
a ball nut drive connected to an output shaft, the ball nut drive comprising a piston configured to act on a sector shaft;
a first drive unit operatively connected to the output shaft by a first helical gear transmission and configured to apply a first steering assist torque to the output shaft; and
a second drive unit operatively connected to the output shaft by a second helical gear transmission configured to apply a second steering assist torque to the output shaft,
wherein the first drive unit defines a first longitudinal axis and has a first rotational position about the first longitudinal axis, and
wherein the second drive unit defines a second longitudinal axis and has a second rotational position which differs from the first rotational position about the second longitudinal axis.

2. The steering gear according to claim 1, wherein the first drive unit and the second drive unit are arranged parallel to each other and have an inclination angle of greater than or less than 90° to a third longitudinal axis of the output shaft.

3. The steering gear according to claim 1, wherein:
the first drive unit and the second drive unit are arranged parallel to each other,
the first drive unit has a first inclination angle to a transverse axis of the output shaft, and
the second drive unit has a second inclination angle to the transverse axis of the output shaft, which differs from the first inclination angle.

4. The steering gear according to claim 3, wherein the first inclination angle to the transverse axis of the output shaft has an angular difference to the second inclination angle to the transverse axis of the output shaft.

5. The steering gear according to claim 1, wherein:
the first drive unit has an inclination angle to a third longitudinal axis of the output shaft, and
the second drive unit has a second inclination angle to the longitudinal axis of the output shaft, which differs from the first inclination angle.

6. The steering gear according to claim 5, wherein:
the first drive unit has a first inclination angle to a the transverse axis of the output shaft, and
the second drive unit has a second inclination angle to the transverse axis of the output shaft, which differs from the first inclination angle.

7. The steering gear according to claim 1, wherein the first drive unit and the second drive unit are arranged askew to one another.

8. The steering gear according to claim 1, wherein the first helical gear transmission and the second helical gear transmission are arranged on a same shaft.

9. The steering gear according to claim 1, wherein the first drive unit or the second drive unit comprise a shielding including a first Hall sensor arranged in a first steering control unit or a second Hall sensor arranged in a second steering control unit.

10. The steering gear according to claim 1, wherein the first rotational position of the first drive unit about the first longitudinal axis has an angular difference to the second rotational position of the second drive unit about the second longitudinal axis.
